(19) United States
(12) Patent Application Publication
(10) Pub. No.: US 2026/0359527 A1
(43) Pub. Date: Nov. 12, 2026

(54) INFORMATION PROCESSING DEVICE, AND INFORMATION PROCESSING METHOD

(71) Applicant: Mitsubishi Electric Corporation, TOKYO (JP)

(72) Inventors: Mio OKADA, Tokyo (JP); Shingo MINE, Tokyo (JP); Atsuyoshi YANO, Tokyo (JP); Naoko SAWADA, Tokyo (JP)

(73) Assignee: Mitsubishi Electric Corporation, TOKYO (JP)

(21) Appl. No.: 19/716,447

(22) Filed: Jun. 23, 2026

Related U.S. Application Data
(63) Continuation of application No. PCT/JP2024/001932, filed on Jan. 24, 2024.

(51) Int. Cl. G06F 30/27; G06F 30/10

(52) U.S. Cl. CPC G06F 30/27; G06F 30/10

(57) ABSTRACT

A learning device includes an acquisition unit that acquires learning data including partial shape information as information indicating a set of elements of a shape of a processed part and PMI as information indicating processing matters, an extraction unit that extracts the partial shape information and the PMI from the learning data, and a generation unit that generates a learned model by using the partial shape information and the PMI.

### CROSS-REFERENCE TO RELATED APPLICATION

This application is a continuation application of International Application No. PCT/JP2024/001932 having an international filing date of Jan. 24, 2024, which is hereby expressly incorporated by reference into the present application.

### BACKGROUND OF THE INVENTION

### 1. Field of the Invention

The present disclosure relates to an information processing device, and an information processing method.

### 2. Description of the Related Art

Processing is carried out based on design data such as Computer-Aided Design (CAD) data. Further, Product Manufacturing Information (PMI) is included in the design data. A drawing check is performed on the design data. Here, a technology regarding the drawing check has been proposed (see Patent Reference 1).
Patent Reference 1: Japanese Patent Application Publication No. 2022-105917

In the drawing check, correctness of the PMI is judged. As a method for performing the drawing check, a method using rule information indicating rules is conceivable. However, there are cases where the correctness of the PMI needs to be judged in a comprehensive manner. In such cases where the judgment is made comprehensively, the method using the rule information is unusable. Therefore, when the correctness of the PMI should be judged comprehensively, how to make the judgment is an issue.

### SUMMARY OF THE INVENTION

The object of the present disclosure is to comprehensively judge the correctness of the PMI.

An information processing device according to an aspect of the present disclosure is provided. The information processing device includes an acquisition unit that acquires learning data including partial shape information as information indicating a set of elements of a shape of a processed part and processing matter information as information indicating processing matters, an extraction unit that extracts the partial shape information and the processing matter information from the learning data, and a generation unit that generates a learned model by using the partial shape information and the processing matter information.

According to the present disclosure, the correctness of the PMI can be judged comprehensively.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing an information processing system in a first embodiment;

FIG. 2 is a diagram showing hardware included in a learning device in the first embodiment;

FIG. 3 is a block diagram showing functions of the learning device in the first embodiment;

FIG. 4 is a diagram showing a concrete example of partial shape information and PMI in the first embodiment;

FIG. 5 is a diagram showing an example of a transformation table in the first embodiment;

FIGS. 6(A) and 6(B) are diagrams showing a concrete example of the partial shape information after the transformation and the PMI after the transformation in the first embodiment;

FIG. 7 is a diagram showing a concrete example of an integration process in the first embodiment;

FIG. 8 is a flowchart showing an example of a process executed by the learning device in the first embodiment;

FIG. 9 is a block diagram showing functions of an inference device in the first embodiment;

FIG. 10 is a flowchart showing an example of a process executed by the inference device in the first embodiment;

FIG. 11 is a block diagram showing functions of a learning device in a second embodiment;

FIG. 12 is a flowchart showing an example of a process executed by the learning device in the second embodiment;

FIG. 13 is a block diagram showing functions of an inference device in the second embodiment;

FIG. 14 is a flowchart showing an example of a process executed by the inference device in the second embodiment; and

FIG. 15 is a flowchart showing an example of a process executed by an inference device in a third embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

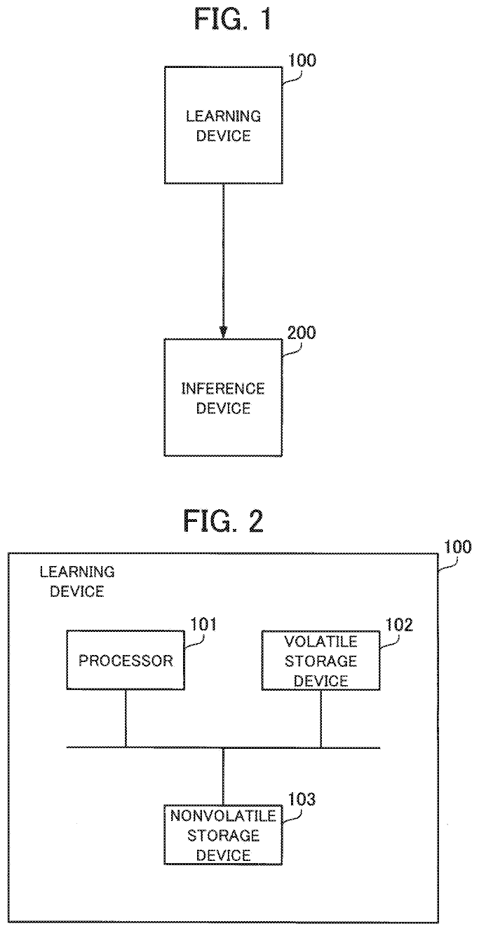

FIG. 1 is a diagram showing an information processing system in a first embodiment. The information processing system includes a learning device 100 and an inference device 200. The learning device 100 and the inference device 200 may be implemented by the same device. The learning device 100 and the inference device 200 may be referred to as information processing devices. The learning device 100 is a device that executes an information processing method. This information processing method may be referred to also as a learning method. The inference device 200 is a device that executes an information processing method. This information processing method may be referred to also as an inference method.

Next, hardware included in the learning device 100 and the inference device 200 will be described below.

FIG. 2 is a diagram showing hardware included in the learning device in the first embodiment. The learning device 100 is a computer. The learning device 100 includes a processor 101, a volatile storage device 102 and a nonvolatile storage device 103.

The processor 101 controls the whole of the learning device 100. The processor 101 is a Central Processing Unit (CPU), a Field Programmable Gate Array (FPGA) or the like, for example. The processor 101 can also be a multiprocessor. Further, the learning device 100 may include processing circuitry.

The volatile storage device 102 is main storage of the learning device 100. The volatile storage device 102 is a Random Access Memory (RAM), for example. The nonvolatile storage device 103 is auxiliary storage of the learning device 100. The nonvolatile storage device 103 is a Hard Disk Drive (HDD) or a Solid State Drive (SSD), for example.

The inference device 200 includes a processor, a volatile storage device and a nonvolatile storage device similarly to the learning device 100. Further, the inference device 200 may include processing circuitry.

In the following, a learning phase and a utilization phase will be described. In the learning phase, the learning device 100 will be described. In the utilization phase, the inference device 200 will be described.

### Learning Phase

Functions of the learning device 100 will be described below.

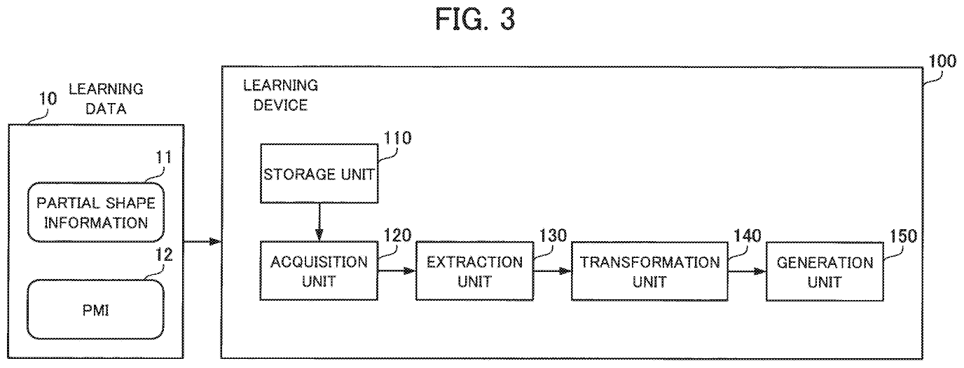

FIG. 3 is a block diagram showing the functions of the learning device in the first embodiment. The learning device 100 includes a storage unit 110, an acquisition unit 120, an extraction unit 130, a transformation unit 140 and a generation unit 150. Incidentally, the transformation unit 140 may be referred to also as a first transformation unit.

The storage unit 110 may be implemented as a storage area reserved in the volatile storage device 102 or the nonvolatile storage device 103.

Part or all of the acquisition unit 120, the extraction unit 130, the transformation unit 140 and the generation unit 150 may be implemented by processing circuitry. Further, part or all of the acquisition unit 120, the extraction unit 130, the transformation unit 140 and the generation unit 150 may be implemented as modules of a program executed by the processor 101. For example, the program executed by the processor 101 is referred to also as an information processing program or a learning program. The information processing program or the learning program has been recorded in a record medium, for example.

The storage unit 110 stores a variety of information. The storage unit 110 may store learning data 10 and a transformation table which will be described later.

The acquisition unit 120 acquires the learning data 10. For example, the acquisition unit 120 acquires the learning data 10 from the storage unit 110. Further, for example, the acquisition unit 120 acquires the learning data 10 from an external device. Incidentally, the external device is a device existing outside the learning device 100. The external device is a cloud server, an external memory or the like, for example. Illustration of the external device is left out.

The learning data 10 will be described below. The learning data 10 is CAD data, for example. The learning data 10 includes partial shape information 11 and PMI 12. The partial shape information 11 is information indicating a set of elements of the shape of a processed part. The partial shape information 11 may also be expressed as information indicating a set of elements of the shape of a part that appears as a result of processing. For example, in cases of opening a hole in a plate, a processing object is the plate and the partial shape information 11 is information indicating a set of elements of the shape of a tubular hole. Specifically, the partial shape information 11 is LINE, CURVE, SURFACE, EDGE, etc. representing a tubular hole (in other words, a circular cylinder). The partial shape information 11 may also be represented by line numbers of the learning data 10 as in a concrete example which will be shown later. The PMI 12 is information indicating processing matters. The PMI 12 is referred to also as processing matter information. Further, the PMI 12 is correct answer data. That is, information indicated by the PMI 12 is information that is correct as the processing matters. In other words, information indicated by the PMI 12 is information that is correct when the processing matters are judged comprehensively. For example, in cases of opening a hole in a plate, the PMI 12 is information regarding the size of the hole. A concrete example of the partial shape information 11 and the PMI 12 will be shown below.

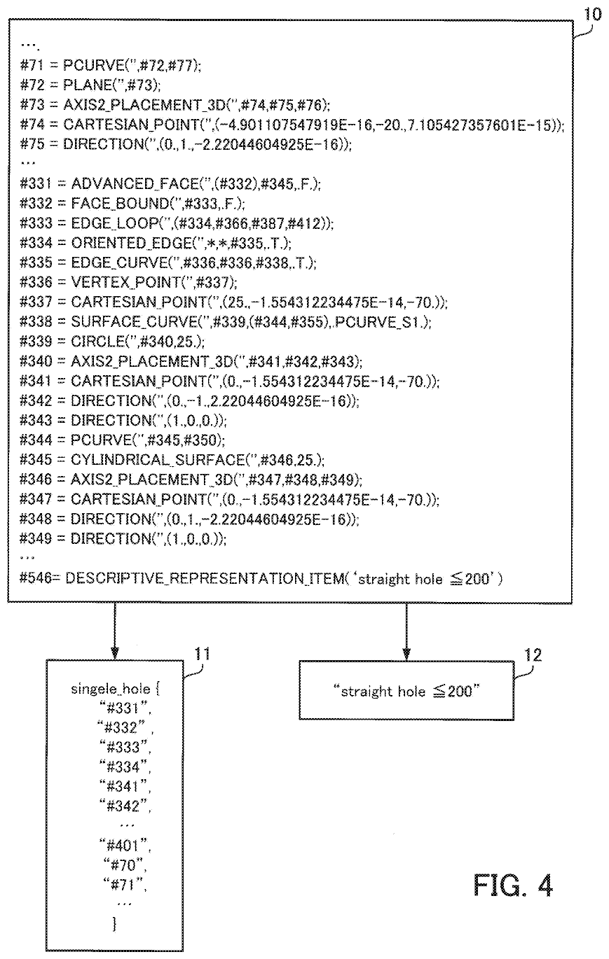

FIG. 4 is a diagram showing a concrete example of the partial shape information and the PMI in the first embodiment. FIG. 4 shows an example of the learning data 10. Further, FIG. 4 shows an example of the partial shape information 11 and the PMI 12. Incidentally, the partial shape information 11 in FIG. 4 indicates line numbers of elements of the shape of a “tubular hole”.

Returning to FIG. 3, the extraction unit 130 will be described below.

The extraction unit 130 extracts the partial shape information 11 and the PMI 12 from the learning data 10. For example, the extraction unit 130 performs the extraction by using a table for identifying the partial shape information 11 and the PMI 12.

The transformation unit 140 transforms at least one of the partial shape information 11 and the PMI 12 into a predetermined format. Specifically, the transformation unit 140 transforms the partial shape information 11 and the PMI 12 into a predetermined format by using a transformation table or a learned model (hereinafter referred to as a transformation learned model).

Here, a reason for performing the transformation will be explained below. When a user (e.g., designer) generates the learning data 10 (e.g., CAD data), the partial shape information 11 and the PMI 12 included in the learning data 10 are described by the user in a variety of representation. For example, the partial shape information 11 and the PMI 12 are represented by colors. For example, the partial shape information 11 and the PMI 12 are represented by texts. For example, the partial shape information 11 and the PMI 12 are represented by symbols. As above, the partial shape information 11 and the PMI 12 are described by the user in a variety of representation. Therefore, the transformation unit 140 transforms the partial shape information 11 and the PMI 12 in order to unify the method of representation.

First, a case where the transformation unit 140 uses the transformation table will be described below. The transformation table is acquired by the acquisition unit 120. For example, the acquisition unit 120 acquires the transformation table from the storage unit 110. The acquisition unit 120 may acquire the transformation table from the external device. An example of the transformation table will be shown below.

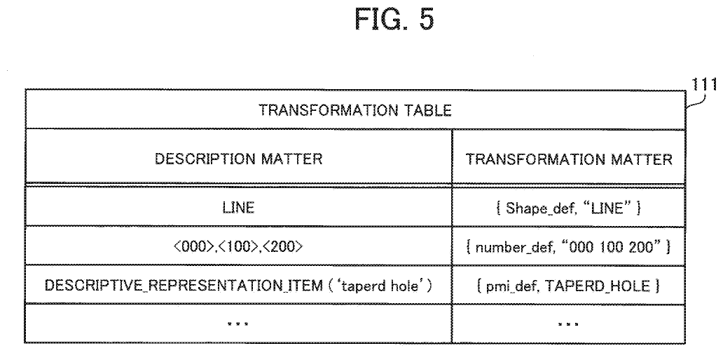

FIG. 5 is a diagram showing an example of the transformation table in the first embodiment. For example, the transformation table 111 has been stored in the storage unit 110. The transformation table 111 may be referred to also as transformation information. The transformation table 111 is information for transforming the partial shape information 11 and the PMI 12 into a predetermined format. The transformation table 111 includes items of description matter and transformation matter. In the item of description matter, description matters are registered. In the item of transformation matter, transformation matters are registered.

The transformation unit 140 transforms the partial shape information 11 and the PMI 12 into a predetermined format by using the transformation table 111. For example, the transformation unit 140 analyzes the partial shape information 11 and thereby generates a tree structure that indicates connective relationship of elements such as a line (LINE), a surface (SURFACE) and a curve (CURVE). Incidentally, the analysis process is similar to a generic analysis process for CAD data. Further, the tree structure is formed with a plurality of nodes. The plurality of nodes represent elements such as LINE, SURFACE and CURVE. The transformation unit 140 transforms the elements such as LINE into a predetermined format by using the transformation table 111. The transformation unit 140 traces the tree structure and successively arranges the elements regarding the nodes while inserting spaces for demarcating the elements. By this, data in a format of text is generated. It is also possible for the transformation unit 140 to first arrange the elements regarding the nodes and thereafter perform the transformation into the predetermined format. The method of tracing the tree structure can be depth priority search, width priority search, or the like. A concrete example of the partial shape information 11 and the PMI 12 after undergoing the transformation will be shown below.

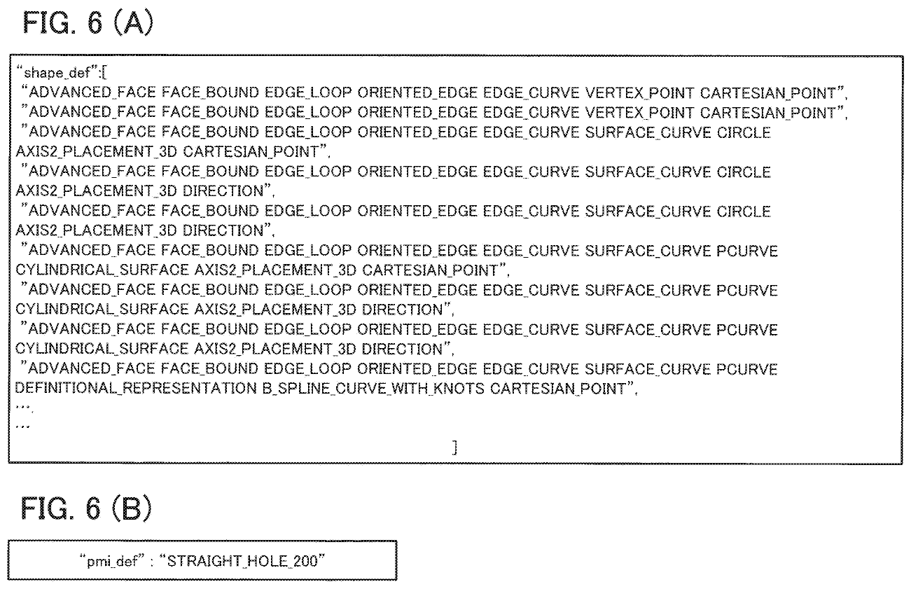

FIGS. 6(A) and 6(B) are diagrams showing a concrete example of the partial shape information after the transformation and the PMI after the transformation in the first embodiment. FIG. 6(A) shows an example of the partial shape information after the transformation. FIG. 6(B) shows an example of the PMI after the transformation.

Next, a case where the transformation unit 140 uses the transformation learned model will be described below. The transformation learned model is acquired by the acquisition unit 120. For example, the acquisition unit 120 acquires the transformation learned model from the storage unit 110. The acquisition unit 120 may acquire the transformation learned model from the external device.

The transformation unit 140 transforms the partial shape information 11 and the PMI 12 into a predetermined format by using the transformation learned model. Specifically, when the transformation unit 140 inputs the partial shape information 11 to the transformation learned model, the transformation learned model outputs the partial shape information 11 represented in the predetermined format (i.e., transformed partial shape information). Further, when the transformation unit 140 inputs the PMI 12 to the transformation learned model, the transformation learned model outputs the PMI 12 represented in the predetermined format (i.e., transformed PMI).

As above, the partial shape information 11 and the PMI 12 are transformed into the predetermined format.

The generation unit 150 generates a learned model by using the partial shape information and the PMI. Incidentally, when the partial shape information has been transformed, the partial shape information to be used for generating the learned model is the partial shape information after the transformation. When the PMI has been transformed, the PMI to be used for generating the learned model is the PMI after the transformation.

The learned model performs outputting of information indicating whether certain PMI is correct or not when the certain PMI is inputted, or performs outputting of correct PMI when certain PMI is inputted. Incidentally, whether the PMI is correct or not means whether or not the PMI is correct as information when performing the processing.

Further, the generation unit 150 may transform the partial shape information after the transformation and the PMI after the transformation into an integrated state and generate the learned model by using the transformed information. An example of the transformed information will be shown below.

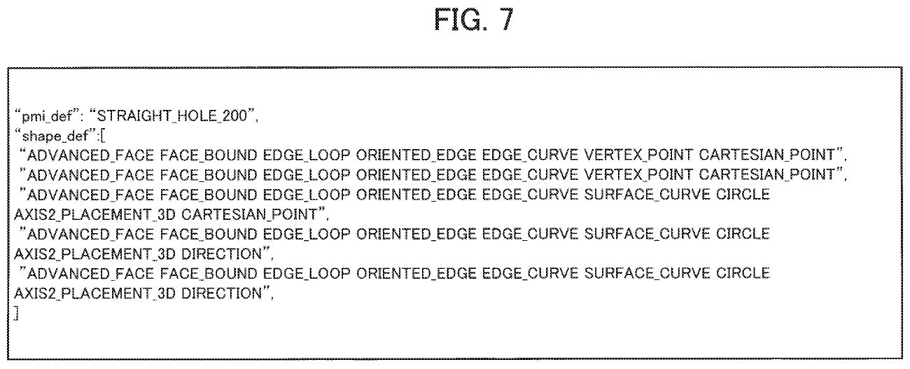

FIG. 7 is a diagram showing a concrete example of an integration process in the first embodiment. FIG. 7 shows a state in which the partial shape information after the transformation and the PMI after the transformation have been transformed by means of the integration (i.e., transformed information).

Next, a process executed by the learning device 100 will be described below by using a flowchart.

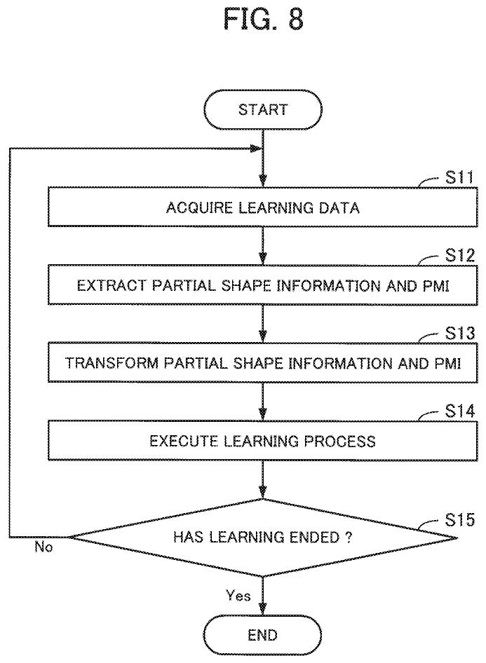

FIG. 8 is a flowchart showing an example of the process executed by the learning device in the first embodiment.

(Step S11) The acquisition unit 120 acquires the learning data 10.

(Step S12) The extraction unit 130 extracts the partial shape information 11 and the PMI 12 from the learning data 10.

(Step S13) The transformation unit 140 transforms the partial shape information 11 and the PMI 12 into the predetermined format.

(Step S14) The generation unit 150 learns a learning model by using the partial shape information after the transformation and the PMI after the transformation.

(Step S15) The generation unit 150 judges whether or not the learning has ended. For example, the learning ends when an end command inputted by the user is acquired by the acquisition unit 120. When the learning has ended, the learning model becomes a learned model. When the learning has not ended, the process advances to the step S11.

The learned model is stored in the inference device 200 or an external device.

The learned model is generated as described above. Since the learned model is generated by using the PMI 12 being correct answer data, the learning method in the learning phase can be referred to as supervised learning.

According to the learning phase, the learning device 100 generates the learned model, for comprehensively judging the correctness of the PMI, by executing the learning by using the learning data. The learning device 100 prepares the learned model. Thus, thanks to the preparation of the learned model, the correctness of the PMI can be judged comprehensively.

The above description has been given of a case where the partial shape information 11 and the PMI 12 are transformed. In cases where the partial shape information 11 has already been represented in the predetermined format, the transformation unit 140 does not transform the partial shape information 11. Further, in cases where the PMI 12 has already been represented in the predetermined format, the transformation unit 140 does not transform the PMI 12. In cases where the partial shape information 11 and the PMI 12 are not transformed, the generation unit 150 generates the learned model by using the partial shape information 11 and the PMI 12.

Next, the utilization phase will be described below.

### Utilization Phase

Functions included in the inference device 200 will be described below.

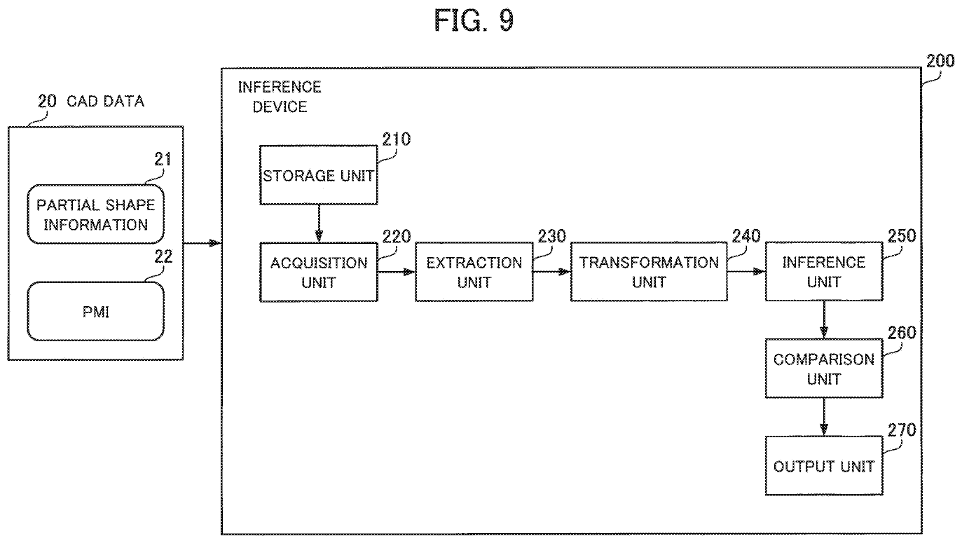

FIG. 9 is a block diagram showing the functions of the inference device in the first embodiment. The inference device 200 includes a storage unit 210, an acquisition unit 220, an extraction unit 230, a transformation unit 240, an inference unit 250, a comparison unit 260 and an output unit 270. Incidentally, the transformation unit 240 may be referred to also as the first transformation unit.

The storage unit 210 may be implemented as a storage area reserved in the volatile storage device or the nonvolatile storage device included in the inference device 200.

Part or all of the acquisition unit 220, the extraction unit 230, the transformation unit 240, the inference unit 250, the comparison unit 260 and the output unit 270 may be implemented by processing circuitry included in the inference device 200. Further, part or all of the acquisition unit 220, the extraction unit 230, the transformation unit 240, the inference unit 250, the comparison unit 260 and the output unit 270 may be implemented as modules of a program executed by the processor included in the inference device 200. For example, the program executed by the processor is referred to also as an information processing program or an inference program. The information processing program or the inference program has been recorded in a record medium, for example.

The storage unit 210 stores a variety of information. The storage unit 210 may store CAD data 20 and the transformation table 111 which will be described later.

The acquisition unit 220 acquires the CAD data 20. For example, the acquisition unit 220 acquires the CAD data 20 from the storage unit 210. Further, for example, the acquisition unit 220 acquires the CAD data 20 from an external device. Incidentally, the CAD data 20 is referred to also as design data. The CAD data 20 includes partial shape information 21 and PMI 22.

The acquisition unit 220 acquires the learned model from the storage unit 210 or the external device. Incidentally, this learned model is the learned model generated by the learning device 100.

The extraction unit 230 extracts the partial shape information 21 and the PMI 22 from the CAD data 20. For example, the extraction unit 230 performs the extraction by using a table for identifying the partial shape information 21 and the PMI 22.

The transformation unit 240 transforms at least one of the partial shape information 21 and the PMI 22 into a predetermined format. Specifically, the transformation unit 240 transforms the partial shape information 21 and the PMI 22 into the predetermined format by using the transformation table 111 or the transformation learned model. The methods using the transformation table 111 and the transformation learned model are the same as those described earlier, and thus repeated explanation thereof is omitted.

The inference unit 250 performs outputting of information indicating whether the PMI 22 is correct or not, or outputting of correct PMI, by using the partial shape information, the PMI and the learned model. Incidentally, when the partial shape information has been transformed, the partial shape information to be inputted to the learned model is the partial shape information after the transformation. When the PMI has been transformed, the PMI to be inputted to the learned model is the PMI after the transformation. For example, when the inference unit 250 inputs the partial shape information after the transformation and the PMI after the transformation to the learned model, the learned model outputs the information indicating whether the PMI 22 is correct or not or the correct PMI.

Further, the inference unit 250 may transform the partial shape information after the transformation and the PMI after the transformation into an integrated state and perform the outputting of the information indicating whether the PMI 22 is correct or not, or the outputting of the correct PMI, by using the transformed information and the learned model.

When the correct PMI has been outputted, the comparison unit 260 compares the PMI 22 or the PMI after the transformation with the correct PMI. For example, the comparison unit 260 makes the comparison by using word2vec or BERT.

When the information indicating whether the PMI 22 is correct or not has been outputted, the output unit 270 outputs the information. For example, the output unit 270 outputs the information to a display of the inference device 200. The outputting of the information enables the designer to recognize whether the PMI 22 is correct or not.

When the comparison has been made, the output unit 270 outputs a comparison result. For example, the output unit 270 outputs the comparison result to the display of the inference device 200. The outputting of the comparison result enables the designer to recognize whether the PMI 22 is sufficient or not.

Next, a process executed by the inference device 200 will be described below by using a flowchart.

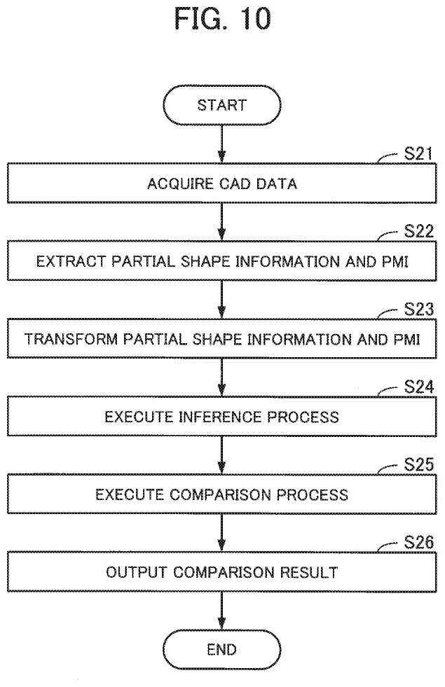

FIG. 10 is a flowchart showing an example of the process executed by the inference device in the first embodiment. Incidentally, it is assumed in the following description that the learned model outputs the correct PMI.

(Step S21) The acquisition unit 220 acquires the CAD data 20.

(Step S22) The extraction unit 230 extracts the partial shape information 21 and the PMI 22 from the CAD data 20.

(Step S23) The transformation unit 240 transforms the partial shape information 21 and the PMI 22 into the predetermined format.

(Step S24) The inference unit 250 performs the outputting of the correct PMI by using the partial shape information after the transformation, the PMI after the transformation, and the learned model.

(Step S25) The comparison unit 260 compares the PMI 22 or the PMI after the transformation with the correct PMI.

(Step S26) The output unit 270 outputs the comparison result.

According to the utilization phase, the inference device 200 is capable of comprehensively judging the correctness of the PMI by using the learned model.

The above description has been given of a case where the partial shape information 21 and the PMI 22 are transformed. In cases where the partial shape information 21 has already been represented in the predetermined format, the transformation unit 240 does not transform the partial shape information 21. Further, in cases where the PMI 22 has already been represented in the predetermined format, the transformation unit 240 does not transform the PMI 22. In cases where the partial shape information 21 and the PMI 22 are not transformed, the inference unit 250 performs the outputting of the information indicating whether the PMI 22 is correct or not, or the outputting of the correct PMI, by using the partial shape information 21, the PMI 22 and the learned model.

Incidentally, there are cases where the PMI 22 is not included in the CAD data 20. When the PMI 22 is not included in the CAD data 20, the inference unit 250 inputs the partial shape information 21 or the partial shape information after the transformation to the learned model. Then, the learned model outputs information indicating that the PMI 22 is not included in the CAD data 20. The output unit 270 outputs the information. The outputting of the information enables the designer to notice that the PMI 22 has not been included in the CAD data 20.

### Second Embodiment

Next, a second embodiment will be described below. In the second embodiment, the description will be given mainly of features different from those in the first embodiment. In the second embodiment, the description is omitted for features in common with the first embodiment.

### Learning Phase

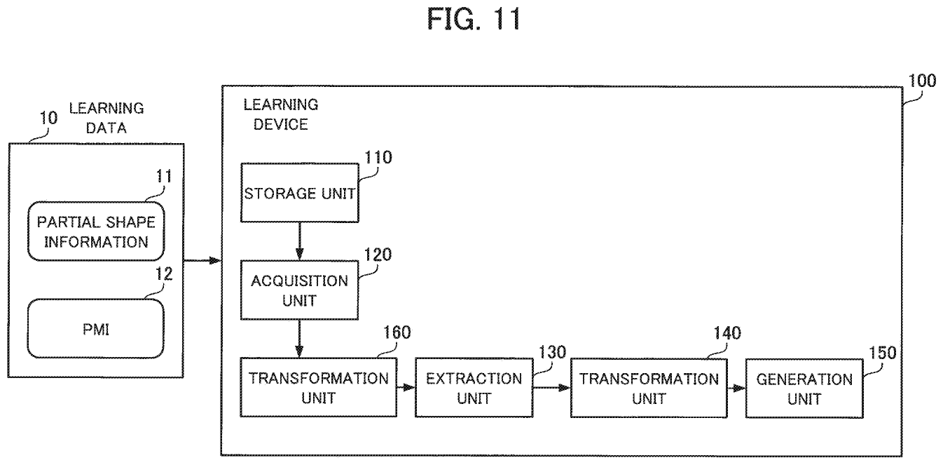

FIG. 11 is a block diagram showing functions of a learning device in the second embodiment. The learning device 100 further includes a transformation unit 160. The transformation unit 160 may be referred to also as a second transformation unit.

Part or the whole of the transformation unit 160 may be implemented by processing circuitry. Further, part or the whole of the transformation unit 160 may be implemented as a module of a program executed by the processor 101.

The format of the learning data 10 in the second embodiment is assumed to be the binary format. When the learning data 10 is not in the ASCII format, the extraction unit 130 cannot perform the extraction. Therefore, the transformation unit 160 transforms the format of the learning data 10 into the ASCII format. In other words, the transformation unit 160 transforms the learning data 10 into a text file. For example, the transformation unit 160 transforms the format of the learning data 10 into the ASCII format by using a table for transforming the format. Thanks to the transformation of the format of the learning data 10 into the ASCII format, the extraction unit 130 is capable of performing the extraction.

Next, a process executed by the learning device 100 will be described below by using a flowchart.

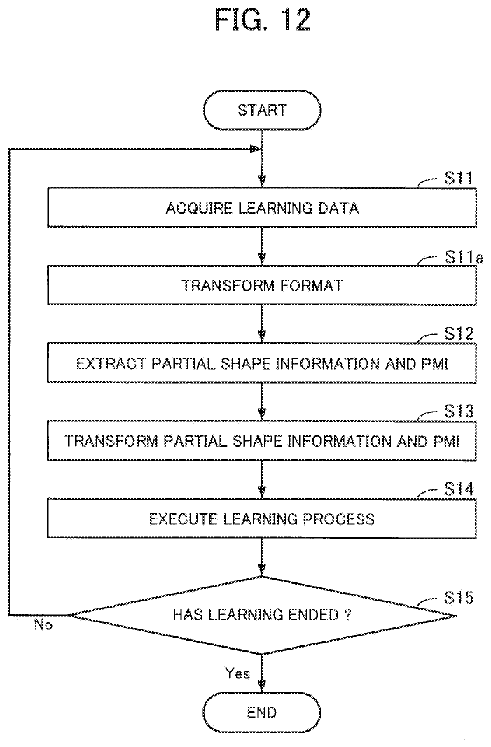

FIG. 12 is a flowchart showing an example of the process executed by the learning device in the second embodiment. The process in FIG. 12 differs from the process in FIG. 8 in that step S11a is executed. Thus, the step S11a in FIG. 12 will be described below. Then, the description will be omitted for processing other than the step S11a.

(Step S11a) The transformation unit 160 transforms the format of the learning data 10 into the ASCII format.

Incidentally, in the step S12, the extraction unit 130 extracts the partial shape information 11 and the PMI 12 from the transformed learning data 10.

According to the second embodiment, the learning device 100 is capable of executing the learning even when the format of the learning data 10 is the binary format.

### Utilization Phase

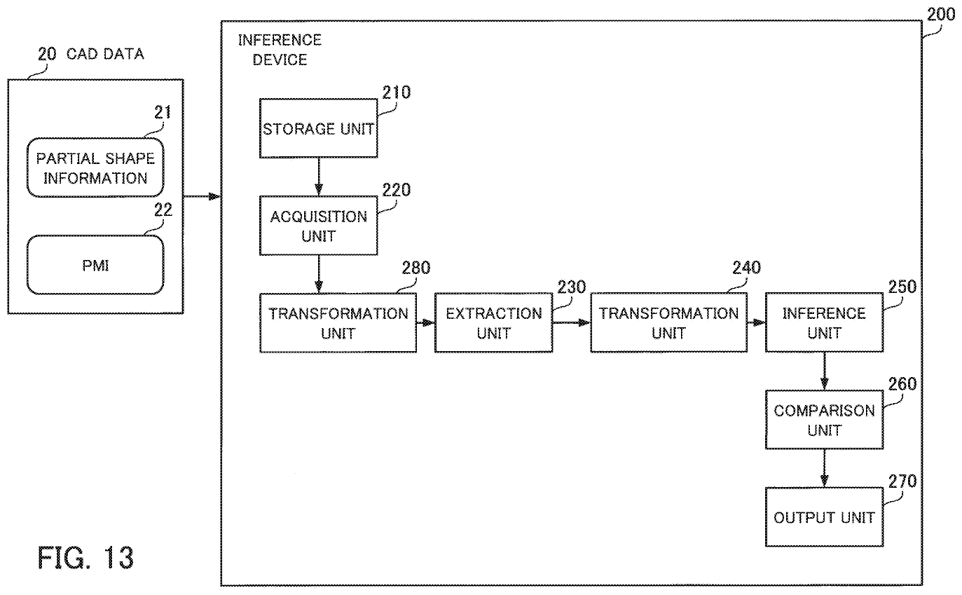

FIG. 13 is a block diagram showing functions of an inference device in the second embodiment. The inference device 200 further includes a transformation unit 280. The transformation unit 280 may be referred to also as the second transformation unit.

Part or the whole of the transformation unit 280 may be implemented by processing circuitry included in the inference device 200. Further, part or the whole of the transformation unit 280 may be implemented as a module of a program executed by the processor included in the inference device 200.

The format of the CAD data 20 in the second embodiment is assumed to be the binary format. When the CAD data 20 is not in the ASCII format, the extraction unit 230 cannot perform the extraction. Therefore, the transformation unit 280 transforms the format of the CAD data 20 into the ASCII format. In other words, the transformation unit 280 transforms the CAD data 20 into a text file. For example, the transformation unit 280 transforms the format of the CAD data 20 into the ASCII format by using a table for transforming the format. Thanks to the transformation of the format of the CAD data 20 into the ASCII format, the extraction unit 230 is capable of performing the extraction.

Next, a process executed by the inference device 200 will be described below by using a flowchart.

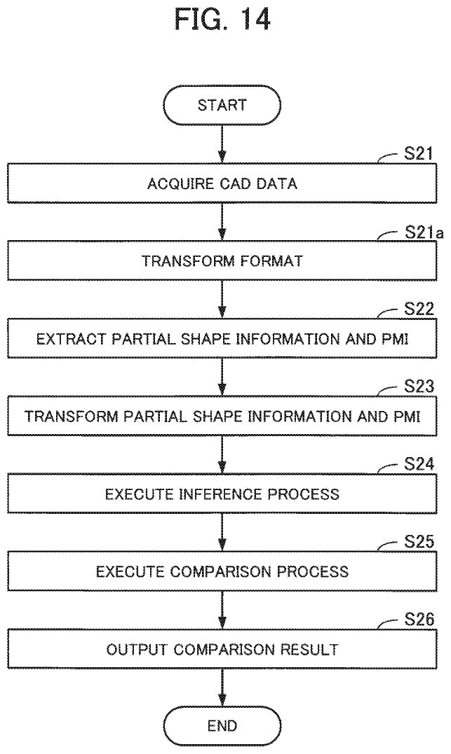

FIG. 14 is a flowchart showing an example of the process executed by the inference device in the second embodiment. The process in FIG. 14 differs from the process in FIG. 10 in that step S21a is executed. Thus, the step S21a in FIG. 14 will be described below. Then, the description will be omitted for processing other than the step S21a.

(Step S21a) The transformation unit 280 transforms the format of the CAD data 20 into the ASCII format.

Incidentally, in the step S22, the extraction unit 230 extracts the partial shape information 21 and the PMI 22 from the transformed CAD data 20.

According to the second embodiment, the inference device 200 is capable of making the inference even when the format of the CAD data 20 is the binary format.

### Third Embodiment

Next, a third embodiment will be described below. In the third embodiment, the description will be given mainly of features different from those in the first embodiment. In the third embodiment, the description is omitted for features in common with the first embodiment.

### Utilization Phase

In the first embodiment, the description has been given of a case where the entirety of the partial shape information 21 and the PMI 22 included in the CAD data 20 is extracted. In the third embodiment, the description will be given of a case where elements and the like corresponding to PMI as an inference object are extracted from the partial shape information 21.

Next, a process executed by the inference device 200 will be described below by using a flowchart.

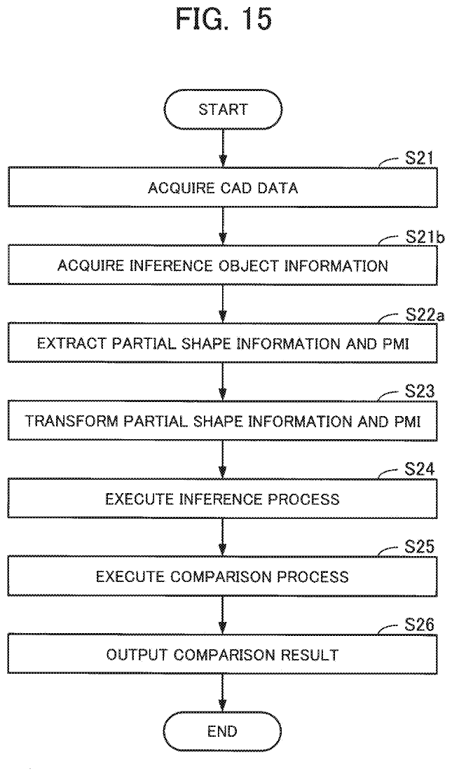

FIG. 15 is a flowchart showing an example of the process executed by the inference device in the third embodiment. The process in FIG. 15 differs from the process in FIG. 10 in that steps S21b and 22a are executed. Thus, the steps S21b and 22a in FIG. 15 will be described below. Then, the description will be omitted for processing other than the steps S21b and 22a.

(Step S21b) The acquisition unit 220 acquires inference object information from the storage unit 210 or the external device. Incidentally, the inference object information indicates elements of a shape having relationship with the PMI as the inference object and the PMI as the inference object.

(Step S22a) The extraction unit 230 extracts the partial shape information 21 indicating the elements of the shape having relationship with the PMI as the inference object and the PMI 22 as the inference object from the CAD data 20 by using the inference object information.

According to the third embodiment, the inference device 200 does not extract the entirety of the partial shape information 21 and the PMI 22 included in the CAD data 20. Therefore, the time for executing the transformation process (i.e., the step S23) and the inference process (i.e., the step S24) is short. Incidentally, when the transformation process is not executed, the time for executing the inference process is short. Thus, the inference device 200 is capable of reducing the processing load.

Features in the embodiments described above can be appropriately combined with each other.

### DESCRIPTION OF REFERENCE CHARACTERS

10: learning data, 11: partial shape information, 12: PMI, 20: CAD data, 21: partial shape information, 22: PMI, 100: learning device, 101: processor, 102: volatile storage device, 103: nonvolatile storage device, 110: storage unit, 111: transformation table, 120: acquisition unit, 130: extraction unit, 140: transformation unit, 150: generation unit, 160: transformation unit, 200: inference device, 210: storage unit, 220: acquisition unit, 230: extraction unit, 240: transformation unit, 250: inference unit, 260: comparison unit, 270: output unit, 280: transformation unit

What is claimed is:

1. An information processing device comprising:
acquiring circuitry to acquire learning data including partial shape information as information indicating a set of elements of a shape of a processed part and processing matter information as information indicating processing matters, a format of the learning data being a binary format;
second transforming circuitry to transform the format of the learning data into an ASCII format;
extracting circuitry to extract the partial shape information and the processing matter information from the transformed learning data; and
generating circuitry to generate a learned model by using the partial shape information and the processing matter information.

2. The information processing device according to claim 1, further comprising first transforming circuitry to transform at least one of the partial shape information and the processing matter information into a predetermined format, wherein
when the partial shape information has been transformed, the partial shape information to be used for generating the learned model is the partial shape information after the transformation, and
when the processing matter information has been transformed, the processing matter information to be used for generating the learned model is the processing matter information after the transformation.

3. An information processing device comprising:
acquiring circuitry to acquire design data, including partial shape information as information indicating a set of elements of a shape of a processed part and processing matter information as information indicating processing matters, and a learned model;
extracting circuitry to extract the partial shape information and the processing matter information from the design data; and
inferring circuitry to perform outputting of information indicating whether the processing matter information is correct or not, or outputting of correct processing matter information, by using the partial shape information, the processing matter information and the learned model.

4. The information processing device according to claim 3, further comprising first transforming circuitry to transform at least one of the partial shape information and the processing matter information into a predetermined format, wherein
when the partial shape information has been transformed, the partial shape information to be inputted to the learned model is the partial shape information after the transformation, and
when the processing matter information has been transformed, the processing matter information to be inputted to the learned model is the processing matter information after the transformation.

5. The information processing device according to claim 3, further comprising:
comparing circuitry to compare the processing matter information or the processing matter information after the transformation with the correct processing matter information when the correct processing matter information has been outputted; and
outputting circuitry to output a comparison result.

6. The information processing device according to claim 3, further comprising second transforming circuitry, wherein
a format of the design data is a binary format,
the second transforming circuitry transforms the format of the design data into an ASCII format, and
the extracting circuitry extracts the partial shape information and the processing matter information from the transformed design data.

7. The information processing device according to claim 3, wherein
the acquiring circuitry acquires inference object information that indicates elements of a shape having relationship with the processing matter information as an inference object and the processing matter information as the inference object, and
the extracting circuitry extracts the partial shape information indicating the elements of the shape having relationship with the processing matter information as the inference object and the processing matter information as the inference object from the design data by using the inference object information.

8. The information processing device according to claim 3, further comprising outputting circuitry, wherein
the processing matter information is not included in the design data,
the inferring circuitry inputs the partial shape information or the partial shape information after transformation to the learned model, and
the outputting circuitry outputs information outputted from the learned model and indicating that the processing matter information is not included in the design data.

9. An information processing method performed by an information processing device, the information processing method comprising:
acquiring learning data including partial shape information as information indicating a set of elements of a shape of a processed part and processing matter information as information indicating processing matters, a format of the learning data being a binary format;
transforming the format of the learning data into an ASCII format;
extracting the partial shape information and the processing matter information from the transformed learning data; and
generating a learned model by using the partial shape information and the processing matter information.

10. An information processing method performed by an information processing device, the information processing method comprising:
acquiring design data, including partial shape information as information indicating a set of elements of a shape of a processed part and processing matter information as information indicating processing matters, and a learned model;
extracting the partial shape information and the processing matter information from the design data; and
performing outputting of information indicating whether the processing matter information is correct or not, or outputting of correct processing matter information, by using the partial shape information, the processing matter information and the learned model.

11. An information processing device comprising:
a processor to execute a program; and
a memory to store the program which, when executed by the processor, performs processes of,
acquiring learning data including partial shape information as information indicating a set of elements of a shape of a processed part and processing matter information as information indicating processing matters, a format of the learning data being a binary format,
transforming the format of the learning data into an ASCII format,
extracting the partial shape information and the processing matter information from the transformed learning data, and
generating a learned model by using the partial shape information and the processing matter information.

12. An information processing device comprising:
a processor to execute a program; and
a memory to store the program which, when executed by the processor, performs processes of,
acquiring design data, including partial shape information as information indicating a set of elements of a shape of a processed part and processing matter information as information indicating processing matters, and a learned model,
extracting the partial shape information and the processing matter information from the design data, and
performing outputting of information indicating whether the processing matter information is correct or not, or outputting of correct processing matter information, by using the partial shape information, the processing matter information and the learned model.
